(19) United States
(12) Patent Application Publication
(10) Pub. No.: US 2015/0121379 A1
(43) Pub. Date: Apr. 30, 2015

(54) INFORMATION PROCESSING METHOD AND ELECTRONIC APPARATUS

(71) Applicant: LENOVO (BEIJING) CO., LTD., Beijing (CN)

(72) Inventor: Yonglai SHI, Beijing (CN)

(21) Appl. No.: 14/472,041

(22) Filed: Aug. 28, 2014

(30) Foreign Application Priority Data
Oct. 30, 2013 (CN) 201310529093.2

(51) Int. Cl. G06F 9/46; G06F 3/0484

(52) U.S. Cl. CPC G06F 9/46; G06F 3/0484
USPC 718/100

(57) ABSTRACT

The present invention discloses an information processing method and an electronic apparatus, the electronic apparatus has a display unit, which is able to present an interactive interface for displaying N applications running in the electronic apparatus, and N is a positive integer. The information processing method includes acquiring a first operation to a first application of the N applications at the T1 moment; controlling the first application to be in a first status in response to the first operation; acquiring a second operation at the T2 moment after the T1 moment; and controlling the electronic apparatus to terminate the process of the second application in response to the second operation.

### CROSS REFERENCE TO RELATED APPLICATIONS

This application claims the benefit under 35 U.S.C. §119(a) of Chinese Patent Application No. 201310529093.2 filed on Oct. 30, 2013, the entire disclosure of which is incorporated herein by reference in its entirety.

### BACKGROUND

The present invention relates to the field of computer technology, and particularly to an information processing method and an electronic apparatus.

With the fast development of electronic apparatus, technology is being applied more and more in everyday life. Richness of functions, strong power of processing capacity, and network access at any time and anywhere of the conventional electronic apparatus such as a smart phone or a PAD makes electronic apparatus more and more popular. The conventional electronic apparatus can release memory using memory clearing software, so that its operation is smoother, which in turn enhances user experience.

However, there is a technical problem that the conventional electronic apparatus may not release the memory selectively at the time of releasing the memory. This is because that the conventional electronic apparatus would release the memory of all applications running in the electronic apparatus at the time of releasing the memory, but may not release the memory of a part of applications in the all applications and may not release the memory of other parts of the applications. Thus, there is a technical problem that the memory may not be released selectively.

### SUMMARY

The embodiments of this application solve the technical problem that the memory may not be released selectively at the time of releasing the memory of the conventional electronic apparatus by providing an information processing method and an electronic apparatus.

The embodiment of this application provides an information processing method applied in an electronic apparatus having a display unit, which is able to present an interactive interface for displaying N applications running in the electronic apparatus, wherein, N is a positive integer. The method includes acquiring a first operation to a first application of the N applications at the T1 moment; controlling the first application to be in a first status in response to the first operation; acquiring a second operation at the T2 moment after the T1 moment; and controlling the electronic apparatus to terminate the process of a second application in response to the second operation; here, the second application is an application other than the first application of the N applications.

Optionally, the N applications are displayed in a row in the interactive interface.

Optionally, acquiring the first operation to the first application of the N applications at the T1 moment specifically includes acquiring a down-slide operation to the first application as the first operation at the T1 moment.

Optionally, controlling the first application to be in the first status in response to the first operation specifically includes: controlling the first application to be in a locked status as the first status in response to the first operation; here, the process corresponding to the first application would not be terminated when the first application is in the locked status.

Optionally, acquiring the second operation at the T2 moment after the T1 moment specifically includes acquiring an operation of terminating the process of the N applications at the T2 moment.

Optionally, when the electronic apparatus is controlled to terminate the process of the second application in response to the second operation, the method further includes controlling the electronic apparatus to prohibit terminating the process of the first application.

Optionally, when the N applications are displayed on the interactive interface, the method further includes acquiring a third operation to a third application in the N applications; controlling the electronic apparatus to terminate the process of the third application in response to the third operation.

Optionally, acquiring the third operation to the third application in the N applications specifically includes acquiring an up-slide operation to the third application as the third operation.

Another embodiment of this application provides an electronic apparatus including a circuit board; a display unit which is connected electrically to the circuit board and presents an interactive interface for displaying N applications running in the electronic apparatus, wherein N is a positive integer; a processing chip which is provided on the circuit board for acquiring a first operation to a first application of the N applications at T1 moment and controlling the first application to be in a first status in response to the first operation, and acquiring a second operation at T2 moment after the T1 moment and controlling the electronic apparatus to terminate the process of a second application; here, the second application is an application other than the first application in the N applications.

Optionally, the N applications are displayed in a row in the interactive interface.

Optionally, the processing chip includes a first acquiring unit for acquiring a down-slide operation to the first application as the first operation at the T1 moment.

Optionally, the processing chip includes a second acquiring unit for acquiring an operation of terminating the process of the N applications at the T2 moment.

Optionally, the processing chip includes a prohibit terminating process unit for controlling the electronic apparatus to prohibit terminating the process of the first application at the time of controlling the electronic apparatus to terminate the process of the second application in response to the second operation.

One or more technical solutions provided by the embodiments of this application at least have the following technical effects or advantages.

First, since in the embodiments of this application, the first operation to the first application of the N applications is acquired at the T1 moment, and then the first application is controlled to be in the first status, and the electronic apparatus is controlled to terminate the process of the second application by the second operation at the T2 moment after the T1 moment, so that memory of the second application is released, and the electronic apparatus is controlled to prohibit terminating the process of the first application, so that memory of the first application is not released but is saved, so as to in turn release the memory selectively. Therefore, the technical problem that the memory may not be released selectively at the time of releasing the memory in the conventional electronic apparatus is solved, which in turn implements the technical effect of releasing the memory selectively and enhances user experience.

Second, since in the embodiments of this application, the N applications are displayed on the interactive interface and the third operation to the third application of the N applications is acquired and the electronic apparatus is controlled to terminate the process of the third application by the third operation, memory of the third application can be released accurately, so that selectivity of terminating the operation of the process is increased, which is more convenient for the user.

### BRIEF DESCRIPTION OF THE DRAWINGS

In order to describe the technical solution of the embodiment of the invention more clearly, the accompanying drawings necessary for the description of the embodiments are explained simply. The accompanying drawings in the following description are only exemplary embodiments of the invention.

FIG. 1 is a structural diagram of displaying the N applications in the interactive interface in the embodiments of this application.

FIG. 2 is a flow chart of the information processing method in the embodiments of this application.

FIG. 3 is a first type of structural diagram of executing the first operation to the first application in the interactive interface in the embodiments of this application.

FIG. 4 is a second type of structural diagram of executing the first operation to the first application in the interactive interface in the embodiments of this application.

FIG. 5 is a structural diagram of executing the second operation in the interactive interface in the embodiments of this application.

FIG. 6 is a structural diagram after executing the second operation in the interactive interface in the embodiments of this application.

FIG. 7 is a structural diagram of executing the third operation to the second application in the interactive interface in the embodiments of this application.

FIG. 8 is a structural diagram of the electronic apparatus in the embodiments of this application.

### DETAILED DESCRIPTION

The respective embodiments according to the present invention are described in detail with reference to the accompanying drawings. Here, it is noted that the same reference number is given to constituent parts with substantially the same or similar structures and functions, and the repetitive description thereof is omitted.

The embodiments of this application solve the technical problem that the memory may not be released selectively at the time of releasing the memory of the conventional electronic apparatus by providing an information processing method and an electronic apparatus.

The technical solution of the embodiment of this application has an overall concept for solving the above-described technical problem.

Since in the embodiments of this application, the first operation to the first application of the N applications is acquired at the T1 moment, and then the first application is controlled to be in the first status, and the electronic apparatus is controlled to terminate the process of the second application by the second operation at the T2 moment after the T1 moment, so that the memory of the second application is released, and the electronic apparatus is controlled to prohibit terminating the process of the first application, so that the memory of the first application is not released but is saved, so as to in turn release the memory selectively. Therefore, the technical problem that the memory may not be released selectively at the time of releasing the memory in the conventional electronic apparatus is solved, which in turn implements the technical effect of releasing the memory selectively and enhances the user experience better.

In order to understand the above-described technical solution better, it is explained in detail in combination with the accompanying drawings of the specification and the specific implementation mode.

One embodiment of this application provides an information processing method applied in an electronic apparatus having a display unit, which is able to present an interactive interface for displaying N applications running in the electronic apparatus, wherein, N is a positive integer.

Wherein the electronic apparatus is, for example, an electronic apparatus such as a tablet computer, a smart phone, a notebook computer, and further, the display unit is, for example, a Liquid Crystal Display, a LED touch screen, a LCD touch screen, or the like.

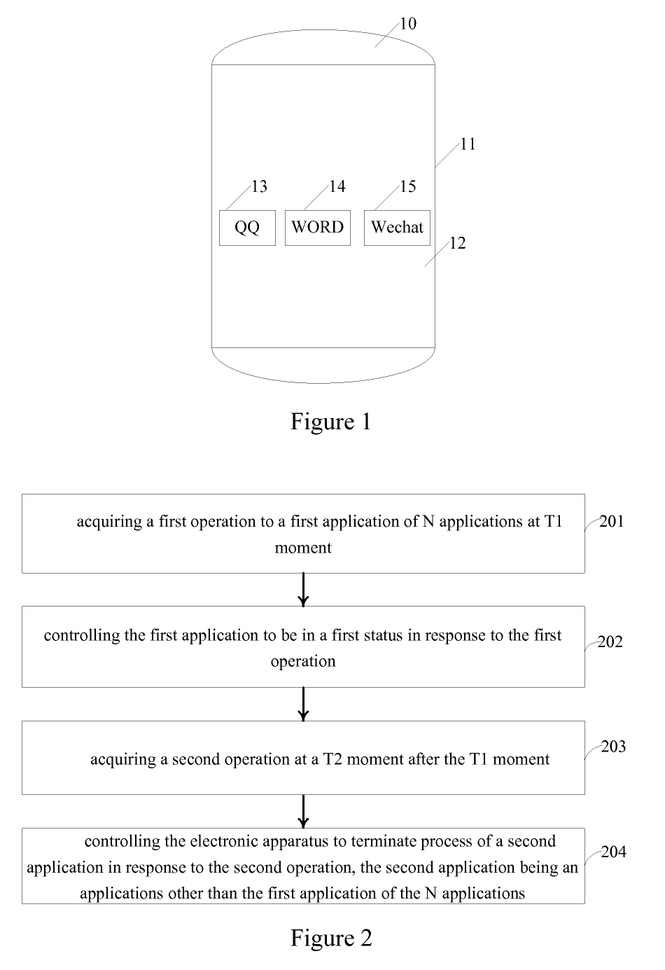

For example, referring to FIG. 1, an interactive interface 12 is displayed on a touch control screen 11 of a smart phone 10. When a QQ application, a WORD application, and a Wechat application are running in the smart phone 10, the QQ application 13, the WORD application 14, and the Wechat application 15 are displayed on the interactive interface 12.

Referring to FIG. 2, the method includes:

Step 201: acquiring a first operation to a first application of the N applications at T1 moment;

Step 202: controlling the first application to be in a first status in response to the first operation;

Step 203: acquiring a second operation at T2 moment after the T1 moment;

Step 204: controlling the electronic apparatus to terminate the process of a second application in response to the second operation; here, the second application is an application other than the first application of the N applications.

Wherein in step 201, the first operation to the first application of the N applications is acquired at the T1 moment.

In the specific implementation procedure, the T1 moment is any one moment when the N applications are displayed on the interactive interface. For example, with reference to FIG. 1, during the period from 12:15:15 to 12:25:25, the QQ application 13, the WORD application 14 and the Wechat application 15 are displayed on the interactive interface 12, and the T1 moment is any one moment between 12:15:15 and 12:25:25. Of course, the T1 moment may also be 12:15:15.

In particular, when the N applications are displayed on the interactive interface, they can be displayed in a row. Of course, they can also be displayed in a column manner. For example, with reference to FIG. 2, the QQ application 13, the WORD application 14 and the Wechat application 15 are arranged in a row, that is, it represents that the N applications are displayed in a row in the interactive interface 12.

In particular, when the N applications are displayed in a row in the interactive interface, a down-slide operation to the first application is acquired as the first operation at the T1 moment. Of course, the first operation may also be an up-slide operation to the first application. Of course, the first operation may also be an operation of clicking or double clicking of the first application. Hereinafter, the first operation being the down-slide operation is taken as a specific example.

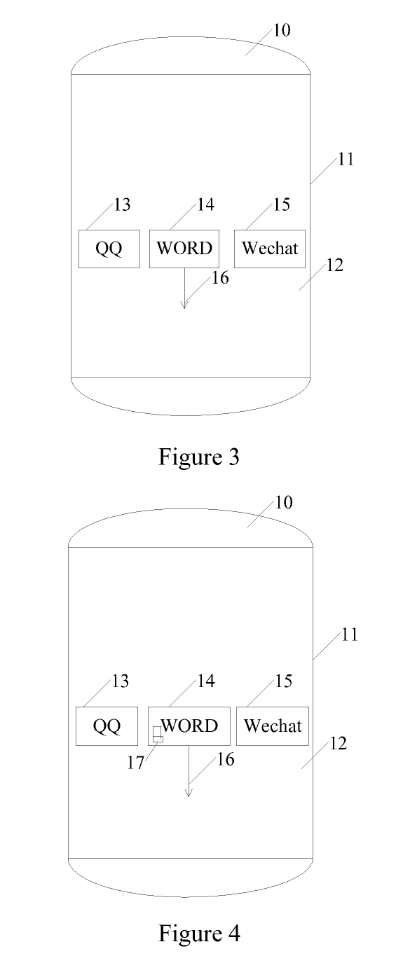

For example, with reference to FIG. 3, in the procedure of displaying the QQ application 13, the WORD application 14 and the Wechat application 15 in a row on the interactive interface 12, at 12:16:30, an operation to the WORD application 14 is detected, and trace of movement of the operation is a directional line 16, so the operation can be determined as the down-slide operation based on the directional line 16, that is, the down-slide operation can be determined as the first operation, and thus, the first operation to the WORD application 14 is acquired.

In particular, when the N applications are displayed in a column on the interactive interface, a left-slide operation to the first application is acquired as the first operation at the T1 moment. Of course, the first operation may also be a right-slide operation to the first application. Of course, the first operation may also be the operation of clicking or double clicking of the first application. This application does not make any specific limitations.

Step 202 is executed next, whereby the first application is controlled to be in the first status in response to the first operation. In the specific implementation procedure, the first application is controlled to be in a locked status as the first status in response to the first operation. Here, when the first application is in the locked status, the process of the first application would not be terminated, so that the memory of the first application would not be released.

In particular, by the first operation acquired in step 201, the first application is controlled to be in the locked status therewith, so that the first application is prohibited from being terminated at the time of executing an operation for terminating the process, and the result is that the memory of the first application would not be released.

In particular, when the first application is in the first status, the first application can be displayed on the interactive interface in a first display mode, and the first display mode is different from a second display mode of the interactive interface displaying the first application at the T1 moment, so that the user can distinguish the application in the first status and the application not in the first status of the N applications accurately, which in turn facilitates operation by the user.

For example, with reference to FIG. 4, in the procedure of displaying the QQ application 13, the WORD application 14 and the Wechat application 15 in a row on the interactive interface 12, at 12:16:30, when the down-slide operation to the WORD application 14 is detected, the WORD application 14 is displayed in the interactive interface 12 in the first display mode. Here, when the WORD application 14 is displayed in the first display mode, a lock pattern 17 is added in a display region where the WORD application 14 is displayed, and when the WORD application 14 is displayed in a second display mode at the T2 moment, the lock pattern 17 is not added in the display region where the WORD application 14 is displayed, as shown in FIG. 3 specifically.

Step 203 is executed next, whereby the second operation is acquired at the T2 moment after the T1 moment. In the specific implementation procedure, at the T2 moment, a process termination operation for terminating the N applications is acquired. Here, the second operation is different from the first operation.

Wherein, the T2 moment is any one moment in the procedure of displaying the N applications on the interactive interface and after the TI moment, for example, during the period from 12:15:15 to 12:25:25, the QQ application 13, the WORD application 14 and the Wechat application 15 are displayed on the interactive interface 12. For example, when the T1 moment is 12:17:15, the T2 moment is any one moment between 12:17:15 and 12:25:25, and of course, the T2 moment may also be 12:25:25.

In particular, at the T2 moment, the process termination operation is acquired, when a process termination key is displayed on the display unit, the process termination operation may be a click operation to the process termination key, and may also be a specific gesture operation. For example, it may be an operation of drawing a circle clockwise, an operation of drawing a circle anticlockwise, and an operation of drawing a triangle or the like. Hereinafter, the second operation being the click operation to the process termination key is taken as an example.

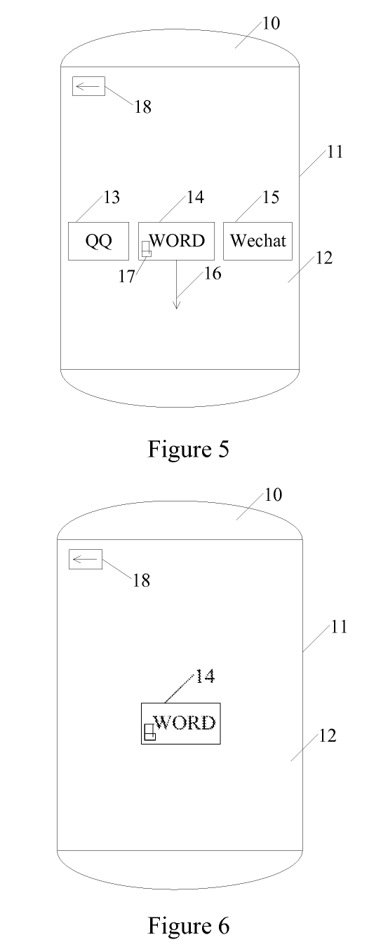

For example, with reference to FIG. 5, in the procedure of displaying the QQ application 13, the WORD application 14 and the Wechat application 15 in a row on the interactive interface 12, at 12:16:25, the down-slide operation is carried out to the WORD application 14, so that the WORD application 14 is displayed in the first display mode. In addition, at 12:17:25, a click operation to a process termination key 18 is acquired, and the click operation to the process termination key 18 is detected as the second operation by a capacitive transducer on the touch control screen 11.

Step 204 is executed next, whereby the electronic apparatus is controlled to terminate the process of the second application in response to the second operation. Here, the second application is the application other than the first application of the N applications.

In the specific implementation procedure, when the electronic apparatus is controlled to terminate the process of the second application in response to the second operation, the electronic apparatus is further controlled to prohibit terminating the process of the first application. Since the process of the second application is terminated, so that the memory of the second application is released, and the process of the first application is not terminated, so that the memory of the first application is not released, which in turn enables selective release of the memory, thereby enhancing the user experience.

For example, with reference to FIG. 5, in the procedure of displaying the QQ application 13, the WORD application 14 and the Wechat application 15 in a row on the interactive interface 12, at 12:16:25, the down-slide operation is carried out to the WORD application 14, so that the WORD application 14 is displayed in the first display mode. And, at 12:17:25, the click operation to the process termination key 18 is acquired, at this time, the processes of the QQ application 13 and the Wechat application 15 are terminated, which in turn releases the memory of the QQ application 13 and the Wechat application 15, while the process of the WORD application 14 is still running, so that the memory of the WORD application 14 is not released but is saved. Therefore, the result is that the WORD application 14 is displayed in the first display mode on the interactive interface 12, and the QQ application 13 and the Wechat application 15 are not displayed on the interactive interface 12, as shown in FIG. 6 specifically.

In another embodiment, when the N applications are displayed on the interactive interface, the method further includes acquiring a third operation to a third application in the N applications; controlling the electronic apparatus to terminate the process of the third application in response to the third operation; here, the third operation is different from each of the first operation and the second operation.

In the specific implementation procedure, when the N applications are displayed in a row on the interactive interface, when the first operation is the down-slide operation, the third operation may be the up-slide operation to the third application. When the first operation is the up-slide operation, the third operation may be the down-slide operation to the third application. Here, the third application is any one application of the N applications.

In particular, when the N applications are displayed in a column on the interactive interface, when the first operation is the left-slide operation, the third operation may be the right-slide operation to the third application. When the first operation is the right-slide operation, the third operation may be the left-slide operation to the third application.

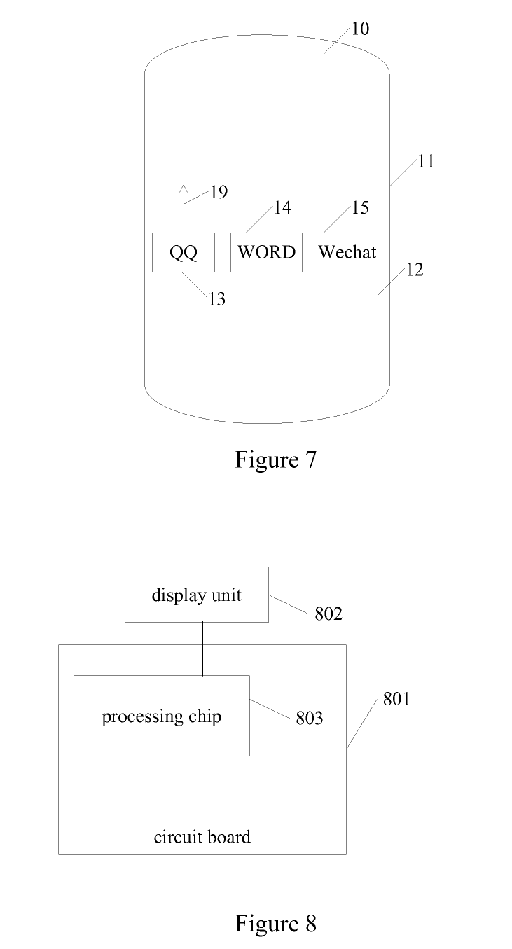

For example, with reference to FIG. 7, in the procedure of displaying the QQ application 13, the WORD application 14 and the Wechat application 15 in a row on the interactive interface 12, at 12:16:30, an operation to the WORD application 13 is detected, and the trace of movement of the operation is a directional line 19, the operation can be determined as the up-slide operation based on the directional line 19, that is, the up-slide operation can be determined as the third operation. Then, the process of the QQ application 13 is terminated in response to the third operation, so that the memory of the QQ application 13 is released.

One or more technical solutions provided by the embodiments of this application at least have the following technical effects or advantages:

First, since in the embodiment of this application, the first operation to the first application of the N applications is acquired at the T1 moment, and then the first application is controlled to be in the first status, and the electronic apparatus is controlled to terminate the process of the second application by the second operation at the T2 moment after the T1 moment, so that memory of the second application is released, and the electronic apparatus is controlled to prohibit terminating the process of the first application, so that the memory of the first application is not released but is saved, so as to in turn release the memory selectively. Therefore, the technical problem that the memory may not be released selectively at the time of releasing the memory in the conventional electronic apparatus is solved, which in turn implements the technical effect of releasing the memory selectively and enhances the user experience better.

Second, since in the embodiments of this application, the N applications are displayed on the interactive interface and the third operation to the third application of the N applications is acquired and the electronic apparatus is controlled to terminate the process of the third application by the third operation, the memory of the third application can be released accurately, so that selectivity of terminating the operation of the process is increased, which is more convenient for the user.

One embodiment of this application provides an electronic apparatus, and the electronic apparatus is, for example, an electronic apparatus such as a tablet computer, a smart phone, a notebook computer, or the like.

With reference to FIG. 8, the electronic apparatus includes a circuit board 801; a display unit 802 which is connected electrically to the circuit board 801 and presents an interactive interface for displaying N applications running in the electronic apparatus, wherein, N is a positive integer; a processing chip 803 which is provided on the circuit board 801 for acquiring a first operation to a first application of the N applications at T1 moment and controlling the first application to be in a first status in response to the first operation, and acquiring a second operation at T2 moment after the T1 moment and controlling the electronic apparatus to terminate the process of a second application; here, the second application is an application other than the first application in the N applications.

Wherein, the circuit board 801 can be a main-board of the electronic apparatus, further, the processing chip 803 may be an independent processing chip, and may be integrated into a processor.

Further, the display unit 802 is, for example, an electronic apparatus such as a Liquid Crystal Display, a LED touch screen, a LCD touch screen, or the like.

For example, with reference to FIG. 1, the interactive interface 12 is displayed on the touch control screen 11 of the smart phone 10, when the QQ application, the WORD application and the Wechat application are running in the smart phone 10, the QQ application 13, the WORD application 14 and the Wechat application 15 are displayed on the interactive interface 12.

Here, when the N applications are displayed in the interactive interface, they can be displayed in a row or, of course, in a column. For example, with reference to FIG. 2, the QQ application 13, the WORD application 14 and the Wechat application 15 are arranged in a row, that is, it represents that the N applications are displayed in a row on the interactive interface 12.

In particular, when the N applications are displayed in a row on the interactive interface, the down-slide operation to the first application is acquired as the first operation at the T1 moment, of course, the first operation may also be the up-slide operation to the first application, of course, the first operation may also be the operation of clicking or double clicking of the first application. Hereinafter, the first operation being the down-slide operation is taken as a specific example.

Further, the T1 moment is any one moment when the N applications are displayed on the interactive interface, for example, with reference to FIG. 1, during the period from 12:15:15 to 12:25:25, the QQ application 13, the WORD application 14 and the Wechat application 15 are displayed on the interactive interface 12, the T1 moment is any one moment between 12:15:15 and 12:25:25; of course, the T1 moment may also be 12:15:15.

Further, the T2 moment is any one moment in the procedure of displaying the N applications on the interactive interface and after the TI moment, for example, during the period from 12:15:15 to 12:25:25, the QQ application 13, the WORD application 14 and the Wechat application 15 are displayed on the interactive interface 12, and, for example, when the T1 moment is 12:17:15, the T2 moment is any one moment between 12:17:15 and 12:25:25; of course, the T2 moment may also be 12:25:25.

Further, the processing chip 803 includes a first acquiring unit for acquiring the down-slide operation to the first application as the first operation at the T1 moment.

Further, the processing chip 803 includes a second acquiring unit for acquiring the operation of terminating the process of the N applications at the T2 moment.

In particular, when the process termination key is displayed on the display unit, the process termination operation may be the click operation to the process termination key, and may be a specific gesture operation. For example, it may be an operation of drawing a circle clockwise, an operation of drawing a circle anticlockwise, and an operation of drawing a triangle or the like. Hereinafter, the second operation being the click operation to the process termination key is taken as an example.

Further, the processing chip 803 includes a status adjusting unit for controlling the first application to be in the locked status as the first status in response to the first operation; here, when the first application is in the locked status, the process of the first application would not be terminated, so that the memory of the first application would not be released.

Further, the processing chip 803 includes a prohibit terminating process unit for controlling the electronic apparatus to prohibit terminating the process of the first application at the time of controlling the electronic apparatus to terminate the process of the second application in response to the second operation.

In another embodiment, the processing chip 803 includes a processing unit for acquiring the third operation to the third application of the N applications when the N applications are displayed on the interactive interface and controlling the electronic apparatus to terminate the process of the third application in response to the third operation.

Further, when the N applications are displayed in a row on the interactive interface, when the first operation is the down-slide operation, the third operation may be the up-slide operation to the second application. When the first operation is the up-slide operation, the third operation may be the down-slide operation to the second application.

In particular, when the N applications are displayed in a column on the interactive interface, when the first operation is the left-slide operation, the third operation may be the right-slide operation to the second application. When the first operation is the right-slide operation, the third operation may be the left-slide operation to the second application.

One or more technical solutions provided by the embodiments of this application at least have the following technical effects or advantages:

First, since in the embodiment of this application, the first operation to the first application of the N applications is acquired at the T1 moment, and then the first application is controlled to be in the first status, and the electronic apparatus is controlled to terminate the process of the second application by the second operation at the T2 moment after the T1 moment, so that the memory of the second application is released, and the electronic apparatus is controlled to prohibit terminating the process of the first application, so that the memory of the first application is not released but is saved, so as to in turn release the memory selectively. Therefore, the technical problem that the memory may not be released selectively at the time of releasing the memory in the conventional electronic apparatus is solved, which in turn implements the technical effect of releasing the memory selectively and enhances the user experience.

Second, since in the embodiments of this application, the N applications are displayed on the interactive interface and the third operation to the third application of the N applications is acquired and the electronic apparatus is controlled to terminate the process of the third application by the third operation, the memory of the third application can be released accurately, so that selectivity of terminating the operation of the process is increased, which is more convenient for the user.

Though the preferred embodiments of the present invention are described, those skilled in the art can make additional alterations and modifications to these embodiments in case of knowing the basic creative concept. Therefore, the appended claims intend to be defined as including the preferable embodiments as well as all of the alterations and modifications falling into the scope of the present invention.

It is obvious that those skilled in the art can make any modification and variation to the present invention without departing from its spirit and scope of the present invention. Thus, if these modifications and variations of the present invention fall into the scope of the claims of the present invention and the equivalent technology, the present invention intends to incorporate these modifications and variations.

What is claimed is:

1. An information processing method applied in an electronic apparatus having a display unit, which is able to present an interactive interface for displaying N applications running in the electronic apparatus, N being a positive integer, the information processing method comprising:
acquiring a first operation to a first application of the N applications at T1 moment;
controlling the first application to be in a first status in response to the first operation;
acquiring a second operation at a T2 moment after the T1 moment; and
controlling the electronic apparatus to terminate the process of a second application in response to the second operation, the second application being an application other than the first application of the N applications.

2. The method of claim 1, wherein the N applications are displayed in a row manner in the interactive interface.

3. The method of claim 2, wherein acquiring the first operation to the first application of the N applications at the T1 moment comprises acquiring a down-slide operation to the first application as the first operation at the T1 moment.

4. The method of claim 1, wherein controlling the first application to be in the first status in response to the first operation comprises controlling the first application to be in a locked status as the first status in response to the first operation, and when the first application is in the locked status, process corresponding to the first application would not be terminated.

5. The method of claim 1, wherein acquiring the second operation at the T2 moment after the T1 moment comprises acquiring a process termination operation for terminating the N applications at the T2 moment.

6. The method of claim 1, wherein at the time of controlling the electronic apparatus to terminate the process of the second application in response to the second operation, the method further includes controlling the electronic apparatus to prohibit from terminating the process of the first application.

7. The method of claim 2, wherein at the time of displaying the N applications on the interactive interface, the method further comprises:
acquiring a third operation to a third application of the N applications; and
controlling the electronic apparatus to terminate the process of the third application in response to the third operation.

8. The method of claim 7, wherein acquiring the third operation to the third application of the N applications comprises acquiring an up-slide operation as the third operation to the third application.

9. An electronic apparatus comprising:
a circuit board;
a display unit which is connected electrically to the circuit board and for presenting an interactive interface for displaying N applications running in the electronic apparatus, N being a positive integer; and
a processing chip which is provided on the circuit board and for acquiring a first operation to a first application of the N applications at T1 moment and controlling the first application to be in a first status in response to the first operation, and acquiring a second operation at T2 moment after the T1 moment and controlling the electronic apparatus to terminate process of a second application, the second application being an application other than the first application in the N applications.

10. The electronic apparatus of claim 8, wherein the N applications are displayed in a row manner in the interactive interface.

11. The electronic apparatus of claim 10, wherein the processing chip includes a first acquiring unit for acquiring a down-slide operation as the first operation to the first application at the T1 moment.

12. The electronic apparatus of claim 8, wherein the processing chip includes a second acquiring unit for acquiring a process termination operation for terminating the N applications at the T2 moment.

13. The electronic apparatus of claim 12, wherein the processing chip includes a prohibit terminating process unit for controlling the electronic apparatus to prohibit from terminating the process of the first application when the electronic apparatus is controlled to terminate the process of the second application in response to the second operation.
